(19) United States
(12) Patent Application Publication
(10) Pub. No.: US 2013/0321313 A1
(43) Pub. Date: Dec. 5, 2013

(54) METHOD, APPARATUS AND COMPUTER PROGRAM PRODUCT FOR CROPPING SCREEN FRAME

(71) Applicant: HTC Corporation, Taoyuan County (TW)

(72) Inventors: Hung-Yi Huang, Taoyuan County (TW); Chia-Chia Shieh, Taoyuan County (TW); Chih-Ling Chien, Taoyuan County (TW); Yen-Shun Wu, Taoyuan County (TW); Sheng-Wei Li, Taoyuan County (TW); Chien-Chuan Chang, Taoyuan County (TW); Yung-Chao Tseng, Taoyuan County (TW)

(21) Appl. No.: 13/904,018

(22) Filed: May 29, 2013

Related U.S. Application Data
(60) Provisional application No. 61/654,072, filed on May 31, 2012.

(51) Int. Cl. G06F 3/041

(52) U.S. Cl. CPC G06F 3/041
USPC 345/173

(57) ABSTRACT

A screen frame cropping method, a screen frame cropping apparatus, and a computer program product adapted to an electronic apparatus having a touch screen are provided. In the screen frame cropping method, a frame is displayed on the touch screen, and a first touch and a second touch preformed by a user on the touch screen are detected. When the first touch and the second touch satisfy a predetermined condition, a cropped frame of the frame is stored as an image file. The cropped frame is determined according to at least one first touch position of the first touch and at least one second touch position of the second touch.

### CROSS-REFERENCE TO RELATED APPLICATION

This application claims the priority benefits of U.S. provisional application Ser. No. 61/654,072, filed on May 31, 2012. The entirety of the above-mentioned patent applications is hereby incorporated by reference herein and made a part of this specification.

### BACKGROUND

To fit today's busy life, different space-efficient and highly portable mobile apparatuses are developed. Taking personal digital assistants (PDA), PDA phones, and smart phones as examples, they not only offer various functions as conventional communication apparatuses do, but also allow the users to edit files, send/receive e-mails, browse web pages, and perform instant messaging through built-in operating system (OS).

As to a light, slim, and small portable electronic apparatus, the volume thereof has to be very small. Thus, if both a screen and a keyboard are disposed on the electronic apparatus, the size of the screen has to be reduced. To dispose a larger screen within a limited space, a touch screen has been developed recently, in which a keyboard and a screen are integrated and served as the input interface of a portable electronic apparatus, so that both the cost and the surface area for disposing a conventional keyboard are saved.

The operation of the touch screen is very simple and straightforward. A user can perform various operations on the screen by simply touching the screen with a stylus or a finger. Thus, touch screen is a very convenient input interface. However, how to simplify touch gestures and allow a user to operate screen objects or even edit an entire screen frame is an object to be accomplished in the industry.

### SUMMARY OF THE INVENTION

Accordingly, the present invention is directed to a screen frame cropping method and a screen frame cropping apparatus, in which a user is allowed to crop a screen frame through a simple touch operation.

The present invention provides a screen frame cropping method adapted to an electronic apparatus having a touch screen. In the screen frame cropping method, a frame is displayed on the touch screen, and a first touch and a second touch performed by a user are detected on the touch screen. When the first touch and the second touch satisfy a predetermined condition, a cropped frame of the frame is stored as an image file. The cropped frame is determined according to at least one first touch position of the first touch and at least one second touch position of the second touch.

According to an embodiment of the present invention, the screen frame cropping method further includes recognizing the cropped frame by using a character recognition technique to generate at least one character and storing the at least one character as a text file.

The present invention provides a screen frame cropping apparatus including a touch screen, a storage unit, and one or more processing units. The storage unit records a plurality of modules. The processing units are coupled to the touch screen and the storage unit. The processing units access and execute the modules recorded in the storage unit. The modules include a display module, a detection module, and a cropping module. The display module displays a frame on the touch screen. The detection module detects a first touch and a second touch preformed by a user on the touch screen. The cropping module stores a cropped frame of the frame as an image file when the first touch and the second touch satisfy a predetermined condition, where the cropped frame is determined according to at least one first touch position of the first touch and at least one second touch position of the second touch.

According to an embodiment of the present invention, the predetermined condition includes one of a first displacement of the first touch and a second displacement of the second touch being greater than a predetermined value.

According to an embodiment of the present invention, the predetermined condition includes one of the first touch and the second touch starting from a predetermined starting border area of the touch screen.

According to an embodiment of the present invention, the cropped frame is determined according to a first starting touch position of the first touch, a second starting touch position of the second touch, and a first current touch position of the first touch and a second current touch position of the second touch when one of a first displacement of the first touch and a second displacement of the second touch is greater than a predetermined value.

According to an embodiment of the present invention, the cropped frame is a rectangle including a cropping area and a transparent area outside the cropping area, where the cropping area and the transparent area are determined according to a first moving path of the first touch and a second moving path of the second touch.

According to an embodiment of the present invention, the modules further include a character recognition module. The character recognition module recognizes the cropped frame by using a character recognition technique to generate at least one character and stores the at least one character as a text file.

According to an embodiment of the present invention, the predetermined condition includes one of the first touch and the second touch ending at a predetermined ending border area of the touch screen.

According to an embodiment of the present invention, the predetermined condition includes one of a first touch time of the first touch and a second touch time of the second touch being greater than a predetermined value.

According to an embodiment of the present invention, the cropped frame is determined according to a first starting touch position of the first touch, a second starting touch position of the second touch, a first ending touch position of the first touch, and a second ending touch position of the second touch.

The present invention provides a computer program product. The computer program product is loaded into an electronic apparatus to executed following steps. A frame is displayed on a touch screen of the electronic apparatus. A first touch and a second touch performed by a user are detected on the touch screen. When the first touch and the second touch satisfy a predetermined condition, a cropped frame of the frame is stored as an image file. The cropped frame is determined according to at least one first touch position of the first touch and at least one second touch position of the second touch.

As described above, the present invention provides a screen frame cropping method, a screen frame cropping apparatus, and a computer program product. In the present invention, two touches performed by a user on a touch screen are detected, and when these two touches satisfy a predetermined condition, a cropping area is defined to crop a screen frame according to the touch positions of these two touches, so that the cropping operation is simplified. Besides being stored as a single image file, the cropped frame can also be stored as an image file and/or a text file through a character recognition technique. Thereby, a user is allowed to crop screen frames through simple touch operations.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a screen frame cropping apparatus according to an embodiment of the present invention.

FIG. 2 is a flowchart of a screen frame cropping method according to an embodiment of the present invention.

FIG. 3 illustrates an example of a screen frame cropping method according to an embodiment of the present invention.

FIG. 4 illustrates an example of a screen frame cropping method according to an embodiment of the present invention.

FIG. 5 illustrates an example of a screen frame cropping method according to an embodiment of the present invention.

FIGS. 6A-6F illustrate an example of a screen frame cropping method according to an embodiment of the present invention.

FIG. 7 illustrates an example of a screen frame cropping method according to an embodiment of the present invention.

FIG. 8 is a flowchart of a screen frame cropping method according to an embodiment of the present invention.

FIG. 9 illustrates an example of a screen frame cropping method according to an embodiment of the present invention.

FIG. 10 illustrates an example of a screen frame cropping method according to an embodiment of the present invention.

FIG. 11 illustrates an example of a screen frame cropping method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

It can be observed in an image cropping operation that the major action is to define a cropping area. If the object to be cropped is the screen frame displayed by an electronic apparatus, the cropping area can be defined by using the borders of the screen frame as parts of the cropping area. Thereby, in the present invention, a cropping area is defined by taking both the touch operations of a user and the corresponding frame borders into consideration, and whether a cropping operation is executed is determined according to the displacements and durations of the touch operations, so that the user can quickly and conveniently crop screen frames.

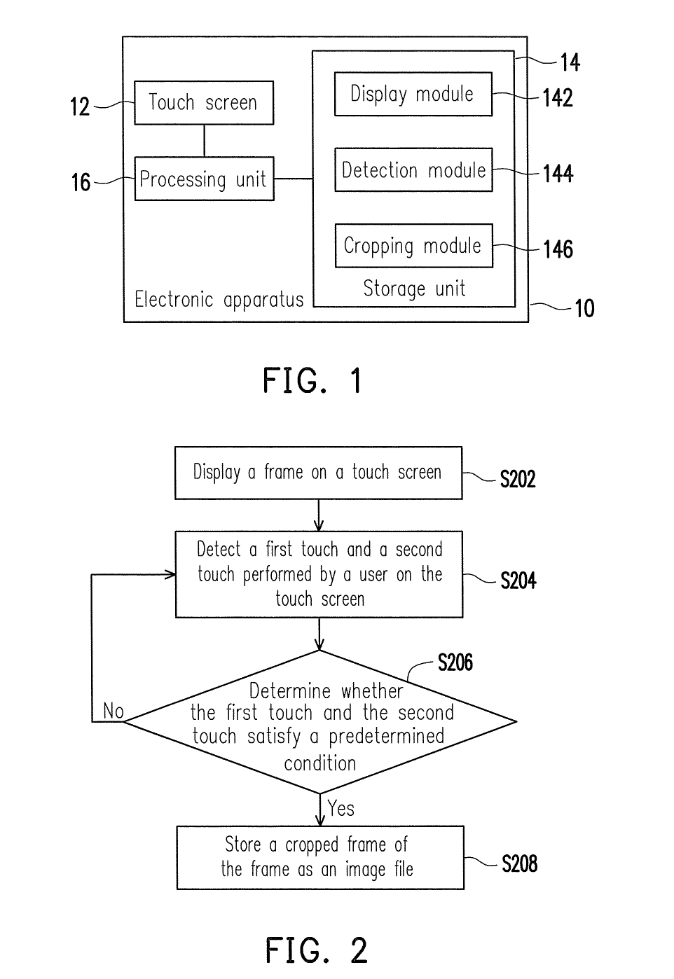

FIG. 1 is a block diagram of a screen frame cropping apparatus according to an embodiment of the present invention. Referring to FIG. 1, the electronic apparatus 10 in the present embodiment may be a cell phone, a smart phone, a personal digital assistant (PDA), a PDA phone, a laptop, or a tablet computer. The electronic apparatus 10 includes a touch screen 12, a storage unit 14, and one or more processing units 16. The functions of aforementioned components will be respectively explained below.

The touch screen 12 is fabricated by integrating resistive, capacitive, or any other type of touch sensing devices with a liquid crystal display (LCD), and which can detect the touch operations performed by a user at the same time when displaying frames of the electronic apparatus 10.

The storage unit 14 is one or a combination of a stationary or mobile random access memory (RAM), read-only memory (ROM), flash memory, hard disk, or any other similar device, and which records a plurality of modules that can be executed by the processing units 16. These modules can be loaded into the processing units 16 to execute a screen frame cropping function.

The processing units 16 is one or a combination of a central processing unit (CPU), a programmable general- or specific-purpose microprocessor, a digital signal processor (DSP), a programmable controller, application specific integrated circuits (ASIC), a programmable logic device (PLD), or any other similar device. The processing units 16 are coupled to the touch screen 12 and the storage unit 14. The processing units 16 access and execute the modules recorded in the storage unit 14 to execute a screen frame cropping function.

Aforementioned modules include a display module 142, a detection module 144, and a cropping module 146. These modules may be computer programs which can be loaded into the processing units 16 to execute the screen frame cropping function. Below, how the electronic apparatus 10 crops a screen frame will be described in detail with reference to embodiments of the present invention.

FIG. 2 is a flowchart of a screen frame cropping method according to an embodiment of the present invention. Referring to FIG. 2, the screen frame cropping method in the present embodiment is suitable for the electronic apparatus 10 illustrated in FIG. 1. Below, the screen frame cropping method will be described in detail with reference to various components of the electronic apparatus 10.

First, the display module 142 displays a frame on the touch screen 12 (step S202). Then, the detection module 144 detects a first touch and a second touch performed by a user on the touch screen 12 (step S204) and determines whether the first touch and the second touch satisfy a predetermined condition (step S206). The predetermined condition may be determined by one or a combination of the displacements, starting positions, ending positions, and durations of the first touch and the second touch.

To be specific, in an embodiment, the detection module 144 detects a first displacement of the first touch on the touch screen 12 and a second displacement of the second touch on the touch screen 12 and determines whether one or both of the first displacement and the second displacement are greater than a predetermined value, so as to determine whether the first touch and the second touch satisfy a predetermined condition. The first displacement and the second displacement may be the displacements of the first touch and the second touch in the direction of the axis X or the axis Y on the touch screen 12 or 2-dimensional displacements on the touch screen 12, which is not limited in the present invention. In addition, aforementioned predetermined value may be the product of the screen length (or width) and a predetermined ratio. However, the predetermined value is not limited in the present invention.

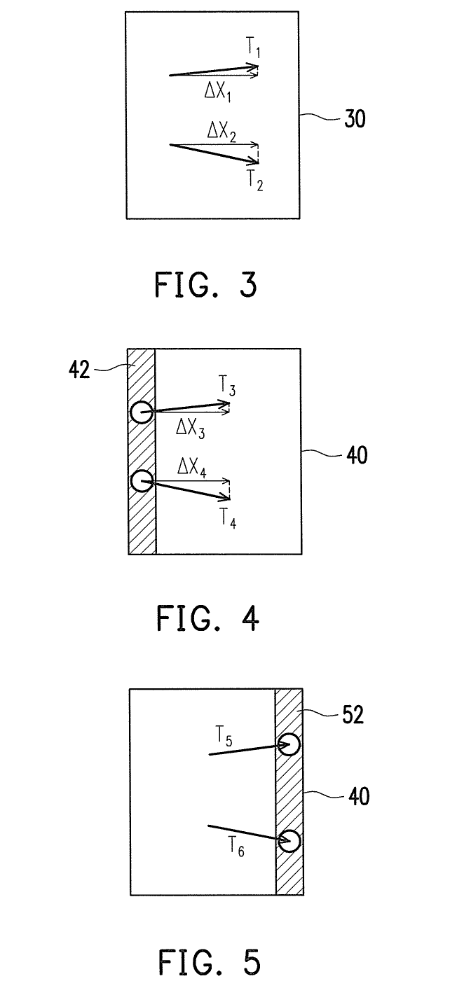

FIG. 3 illustrates an example of a screen frame cropping method according to an embodiment of the present invention. Referring to FIG. 3, in the present example, the electronic apparatus detects a first displacement ΔX₁ of a first touch T₁ in the width direction (i.e., the direction of the axis X) of the touch screen 30 and a second displacement ΔX₂ of a second touch T₂ in the width direction of the touch screen 30 and determines whether one of the two displacements exceeds 60% of the screen width, so as to determine whether the first touch T₁ and the second touch T₂ satisfy a predetermined condition and execute a screen frame cropping operation accordingly.

In an embodiment, besides determining whether the displacements of the first touch and the second touch are greater than a predetermined value, the detection module 144 further determines whether one or both of the first touch and the second touch start from a predetermined starting border area of the touch screen 12, so as to determine whether the first touch and the second touch satisfy the predetermined condition. Aforementioned predetermined starting border area may be the left/right side area, the top/bottom side area, or both the left/right and top/bottom side area of the touch screen 12 and has a specific width (for example, 1-15 pixels) to the borders of the touch screen 12. However, the predetermined starting border area is not limited in the present invention.

FIG. 4 illustrates an example of a screen frame cropping method according to an embodiment of the present invention. Referring to FIG. 4, in the present example, the electronic apparatus first determines whether a third touch T₃ and a fourth touch T₄ start from a predetermined starting border area 42 of the touch screen 40. When both the third touch T₃ and the fourth touch T₄ start from the predetermined starting border area 42 of the touch screen 40, the electronic apparatus detects a third displacement ΔX₃ of the third touch T₃ in the width direction (i.e., the direction of the axis X) of the touch screen 40 and a fourth displacement ΔX₄ of the fourth touch T₄ in the width direction of the touch screen 40 and determines whether one of the third displacement ΔX₃ and the fourth displacement ΔX₄ exceeds 60% of the screen width, so as to determine whether the third touch T₃ and the fourth touch T₄ satisfy a predetermined condition and execute a screen frame cropping operation accordingly.

In an embodiment, the detection module 144 determines whether the first touch and the second touch satisfy the predetermined condition according to whether one or both of the first touch and the second touch end at the predetermined ending border area of the touch screen 12. Similarly, the predetermined ending border area may be the left/right side area, the top/bottom side area, or both the left/right and top/bottom side area of the touch screen 12 and has a specific width (for example, 1-15 pixels) to the borders of the touch screen 12. However, the predetermined ending border area is not limited in the present invention.

FIG. 5 illustrates an example of a screen frame cropping method according to an embodiment of the present invention. Referring to FIG. 5, in the present example, the electronic apparatus determines whether a fifth touch T₅ and a sixth touch T₆ end at a predetermined ending border area 52 of the touch screen 50. When both the fifth touch T₅ and the sixth touch T₆ end at the predetermined ending border area 52 of the touch screen 50, the electronic apparatus determines that the fifth touch T₅ and the sixth touch T₆ satisfy the predetermined condition and executes a screen frame cropping operation accordingly.

In an embodiment, the detection module 144 detects a first touch time of the first touch on the touch screen 12 and a second touch time of the second touch on the touch screen 12 and determines whether one or both of the first touch time and the second touch time is greater than a predetermined value, so as to determine whether the first touch and the second touch satisfy the predetermined condition. Aforementioned predetermined value may be 1-3 seconds. However, the predetermined value is not limited in the present invention.

It should be noted that in an embodiment, the predetermined condition can be any combination of the displacements, starting positions, ending positions, and touch durations mentioned in foregoing embodiments, and these factors can be set to be applicable to one or both of the first touch and the second touch. For example, when both the first touch and the second touch start from the predetermined starting border area of the touch screen and end at the predetermined ending border area of the touch screen, it can be determined that the first touch and the second touch satisfy the predetermined condition and a screen frame cropping operation can be executed accordingly.

Referring to FIG. 2 again, when the detection module 144 determines that the first touch and the second touch satisfy the predetermined condition, the cropping module 146 stores a cropped frame of the frame displayed on the touch screen 12 as an image file (step S208). Contrarily, when the detection module 144 determines that the first touch and the second touch do not satisfy the predetermined condition, step S204 is executed again so that the detection module 144 continues to detect other touches performed by the user on the touch screen 12. Aforementioned cropped frame is determined according to at least one first touch position of the first touch and at least one second touch position of the second touch.

To be specific, in an embodiment, the cropping module 146 defines a rectangular cropping area by taking both the touch positions of the first touch and the second touch and the borders of the touch screen 12 into consideration. For example, the cropping module 146 defines the upper and lower borders of the cropping area by using the touch positions of the first touch and the second touch and defines the left and right borders of the cropping area by using the left and right borders of the touch screen 12. Similarly, the cropping module 146 may also define the left and right borders of the cropping area by using the touch positions of the first touch and the second touch and defines the upper and lower borders of the cropping area by using the upper and lower borders of the touch screen 12. Aforementioned touch positions of the first touch and the second touch may be the touch starting positions or the touch ending positions of the first touch and the second touch, the positions of the first touch and the second touch when the first touch and the second touch satisfy the predetermined condition, or the highest/lowest positions or leftmost/rightmost positions on the moving paths of the first touch and the second touch. However, the definition of the touch positions of the first touch and the second touch is not limited in the present invention. Additionally, in another embodiment, the cropping module 146 may not use the borders of the touch screen 12 and define the left, right, upper, and lower borders of the cropping area by using only the highest, lowest, leftmost, and rightmost positions on the moving paths of the first touch and the second touch. However, the present invention is not limited thereto.

Below, the definition of the upper and lower borders of the cropping area by using the touch positions of a first touch and a second touch and the definition of the left and right borders of the cropping area by using the left and right borders of the touch screen 12 will be respectively described in detail with reference to an embodiment. Similarly, these embodiments are also applicable to the definition of the left and right borders of the cropping area by using the touch positions of the first touch and the second touch and the definition of the upper and lower borders of the cropping area by using the upper and lower borders of the touch screen 12.

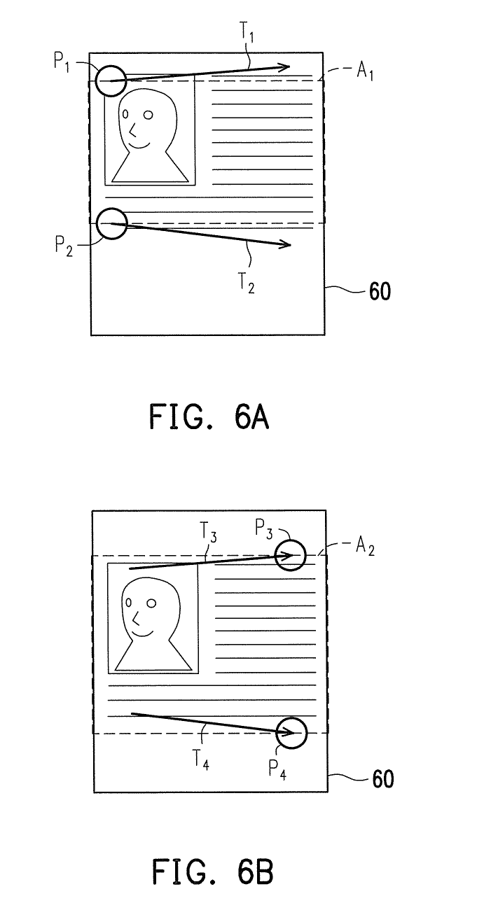

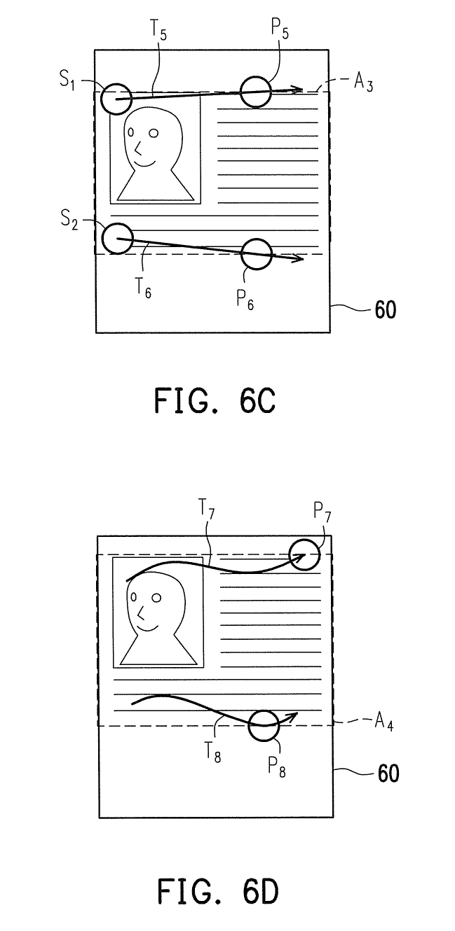

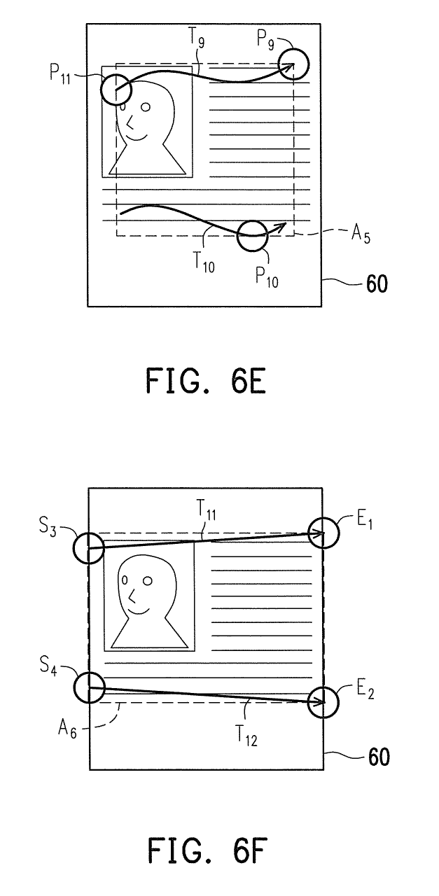

FIGS. 6A-6F illustrate an example of a screen frame cropping method according to an embodiment of the present invention. Referring to FIG. 6A first, in the present example, the electronic apparatus defines the upper and lower borders of a cropping area A₁ by using the touch starting position P₁ of a first touch T₁ and the touch starting position P₂ of a second touch T₂ and defines the left and right borders of the cropping area A₁ by using the left and right borders of the touch screen 60.

Then, referring to FIG. 6B, in the present example, the electronic apparatus defines the upper and lower borders of a cropping area A₂ by using the touch ending positions P₃ of a third touch T₃ and the touch ending positions P₄ of a fourth touch T₄ and defines the left and right borders of the cropping area A₂ by using the left and right borders of the touch screen 60.

Next, referring to FIG. 6C, in the present example, the electronic apparatus defines the upper and lower borders of a cropping area A₃ by using the highest and lowest positions (i.e. positions P₅ and P₆) among the touch starting position S₁ of a fifth touch T₅ and the touch starting position S₂ of a sixth touch T₆ and the positions P₅ and P₆ when the fifth touch T₅ and the sixth touch T₆ satisfy a predetermined condition (for example, the displacement of one of the fifth touch T₅ and the sixth touch T₆ exceeds 60% of the width of the touch screen 60), and the electronic apparatus defines the left and right border of the cropping area A₃ by using the left and right borders of the touch screen 60.

Thereafter, referring to FIG. 6D, in the present example, the electronic apparatus defines the upper and lower borders of a cropping area A₄ by using the highest and lowest positions (i.e. positions P₇ and P₈) on the moving paths of a seventh touch T₇ and an eighth touch T₈ and defines the left and right borders of the cropping area A₄ by using the left and right borders of the touch screen 60.

Next, referring to FIG. 6E, in the present example, the electronic apparatus defines the upper and lower borders and the left and right borders of a cropping area A₅ by using the highest and lowest positions (i.e. positions P₉ and P₁₀) and the leftmost and rightmost positions (i.e. positions P₁₁ and P₉) on the moving paths of a ninth touch T₉ and a tenth touch T₁₀.

Finally, referring to FIG. 6F, in the present example, the electronic apparatus defines the upper, lower, left, and right borders of a cropping area A₆ by using a first starting touch position S₃ of an eleventh touch T₁₁, a second starting touch position S₄ of a twelfth touch T₁₂, a first ending touch position E₁ of the eleventh touch T₁₁, and a second ending touch position E₂ of the twelfth touch T₁₂.

After the electronic apparatus defines the cropping area through one of the techniques described above, the electronic apparatus crops the frame within the cropping area into a cropped frame and stores the cropped frame as an image file. Thereby, the user can select and crop an interested part in a frame displayed on the touch screen and obtain a file of the cropped frame through simple touch operations.

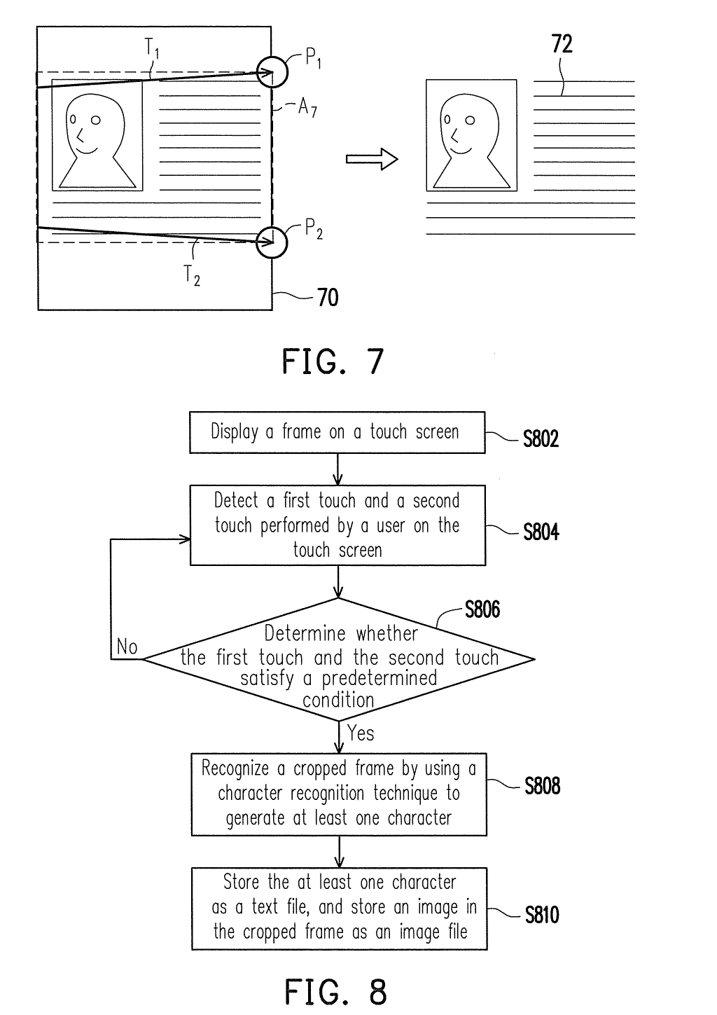

FIG. 7 illustrates an example of a screen frame cropping method according to an embodiment of the present invention. Referring to FIG. 7, in the present example, the electronic apparatus defines the upper, lower, left, and right borders of a cropping area A₇ by using the highest and lowest positions P₁ and P₂ of the first touch T₁ and the second touch T₂ and the left and right borders of the touch screen 70. After the cropping area A₇ is defined, the electronic apparatus crops the frame within the cropping area A₇ into a cropped frame 72 and stores the cropped frame 72 as an image file.

It should be noted that in another embodiment, after the cropping area is defined, the electronic apparatus further recognizes the cropped frame by using a character recognition technique through a character recognition module (not shown) to generate at least one character and stores the recognized character as a text file.

FIG. 8 is a flowchart of a screen frame cropping method according to an embodiment of the present invention. Referring to FIG. 8, the screen frame cropping method in the present embodiment is adapted to the electronic apparatus 10 illustrated in FIG. 1. Below, the screen frame cropping method will be described in detail with reference to various components of the electronic apparatus 10.

First, the display module 142 displays a frame on the touch screen 12 (step S802). Then, the detection module 144 detects a first touch and a second touch performed by a user on the touch screen 12 (step S804) and determines whether the first touch and the second touch satisfy a predetermined condition (step S806). Steps S802-S806 are the same as or similar to steps S202-S206 in the embodiment described above and therefore will not be described herein.

The differences from the embodiment described above lie in that, in the present embodiment, when the detection module 144 determines that the first touch and the second touch satisfy the predetermined condition, the electronic apparatus 10 further recognizes the cropped frame through a character recognition module (not shown) by using a character recognition technique to generate at least one character (step S806). After that, the character recognition module stores the recognized characters as a text file, and the cropping module 146 stores the image in the cropped frame as an image file (step S808). Contrarily, when the detection module 144 determines that the first touch and the second touch do not satisfy the predetermined condition, step S804 is executed again so that the detection module 144 continues to detect other touches performed by the user on the touch screen 12.

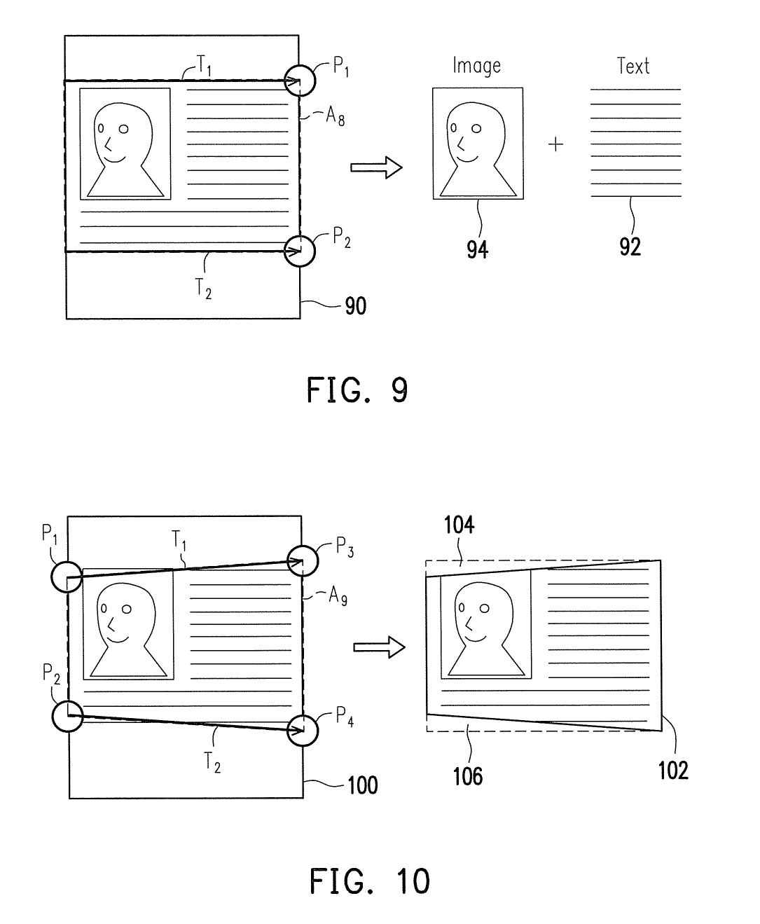

FIG. 9 illustrates an example of a screen frame cropping method according to an embodiment of the present invention. Referring to FIG. 9, in the present example, the electronic apparatus defines the upper, lower, left, and right borders of a cropping area A₈ by using the highest and lowest positions P₁ and P₂ of the first touch T₁ and the second touch T₂ and the left and right borders of the touch screen 90. After the cropping area A₈ is determined, the electronic apparatus recognizes the cropped frame by using a character recognition technique to generate at least one character 92 and stores the recognized characters as a text file. Besides, the electronic apparatus stores the image 94 within the cropping area A₇ as an image file.

Besides the definitions of the rectangular cropping area and rectangular cropped frame described above, in another embodiment, the electronic apparatus may also determine the cropping area according to a first moving path of the first touch and a second moving path of the second touch and keep only the frame within the cropping area visible while the frame within the transparent area outside the cropping area is transparent.

FIG. 10 illustrates an example of a screen frame cropping method according to an embodiment of the present invention. Referring to FIG. 10, in the present example, the electronic apparatus defines a cropping area A₉ (i.e., the area defined by the touch points P₁-P₄) by using the moving paths of the first touch T₁ and the second touch T₂ and the left and right borders of the touch screen 100. While cropping the frame, the electronic apparatus stores the cropped frame 102 as a rectangular image file. However, only the frame within the cropping area A₉ is visible, while the frame within the transparent areas 104 and 106 outside the cropping area A₉ is transparent.

In the embodiments described above, except the definition of the cropping area by using the highest, lowest, leftmost, and rightmost positions of the first touch and the second touch, the borders of the touch screen are used in every definition of the cropping area, and the borders involved are opposite borders (i.e., the left and right borders or the upper and lower borders) of the touch screen. However, in another embodiment, in case that the first touch and the second touch start from or end at different borders, the present invention provides a technique of defining a cropping area by using adjacent borders (for example, the left border and the lower border, or the right border and the upper border). To be specific, in case that the first touch and the second touch start from or end at different borders, the electronic apparatus defines the cropping area according to a first moving path of the first touch, a second moving path of the second touch, and the cross points between these two moving paths and the borders of the touch screen. While cropping the frame, the electronic apparatus keeps the frame within the cropping area visible while the frame within the transparent areas outside the cropping area is transparent.

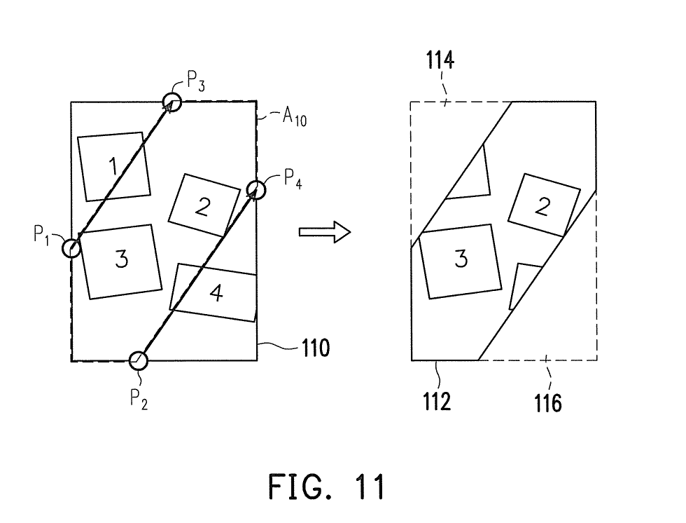

FIG. 11 illustrates an example of a screen frame cropping method according to an embodiment of the present invention. Referring to FIG. 11, in the present example, the electronic apparatus defines a cropping area A₁₀ by using the moving paths of the first touch T₁ and the second touch T₂ and the cross points P₁-P₄ between these two moving paths and the borders of the touch screen. While cropping the frame, the electronic apparatus stores the cropped frame 112 as a rectangular image file. However, only the frame within the cropping area A₁₀ is visible, while the frame within the transparent areas 114 and 116 outside the cropping area A₁₀ is transparent.

Through the screen frame cropping method described above, even if the first touch and the second touch performed by a user start from or end at different borders, the electronic apparatus can still crop the frame selected by the user and store the cropped frame as an image file. It should be mentioned that the screen frame cropping method described above is also applicable when the first touch and the second touch start from different borders but end at the same border or when the first touch and the second touch start from the same border but end at different borders. The present invention is not limited herein.

The present invention further provides a computer program product for executing various steps of the screen frame cropping method described above. The computer program product is composed of a plurality of code snippets (for example, an organization chart establishment code snippet, a form approval code snippet, a settings code snippet, and a deployment code snippet). After these code snippets are loaded into an electronic apparatus and executed by the same, the steps of the screen frame cropping method described above can be accomplished.

As described above, the present invention provides a screen frame cropping method, a screen frame cropping apparatus, and a computer program product. In the present invention, two touches performed by a user on a touch screen are detected, and a cropping operation and a cropping area are defined according to the starting positions, ending positions, moving paths, displacements, and touch durations of these two touches. Thereby, a user can crop screen frames through simple touch operations.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A screen frame cropping method, adapted to an electronic apparatus having a touch screen, the method comprising:
displaying a frame on the touch screen;
detecting a first touch and a second touch performed by a user on the touch screen; and
when the first touch and the second touch satisfy a predetermined condition, storing a cropped frame of the frame as an image file;
wherein the cropped frame is determined according to at least one first touch position of the first touch and at least one second touch position of the second touch.

2. The screen frame cropping method according to claim 1, wherein the predetermined condition comprises:
one of a first displacement of the first touch and a second displacement of the second touch being greater than a predetermined value.

3. The screen frame cropping method according to claim 2, wherein the predetermined condition comprises:
one of the first touch and the second touch starting from a predetermined starting border area of the touch screen.

4. The screen frame cropping method according to claim 3, wherein the cropped frame is determined according to a first starting touch position of the first touch, a second starting touch position of the second touch, and a first current touch position of the first touch and a second current touch position of the second touch when one of a first displacement of the first touch and a second displacement of the second touch is greater than a predetermined value.

5. The screen frame cropping method according to claim 1, wherein the cropped frame is a rectangle comprising a cropping area and a transparent area outside the cropping area, wherein the cropping area and the transparent area are determined according to a first moving path of the first touch and a second moving path of the second touch.

6. The screen frame cropping method according to claim 1 further comprising:
recognizing the cropped frame by using a character recognition technique to generate at least one character; and
storing the at least one character as a text file.

7. The screen frame cropping method according to claim 1, wherein the predetermined condition comprises:
one of the first touch and the second touch ending at a predetermined ending border area of the touch screen.

8. The screen frame cropping method according to claim 1, wherein the predetermined condition comprises:
one of a first touch time of the first touch and a second touch time of the second touch being greater than a predetermined value.

9. The screen frame cropping method according to claim 1, wherein the cropped frame is determined according to a first starting touch position of the first touch, a second starting touch position of the second touch, a first ending touch position of the first touch, and a second ending touch position of the second touch.

10. A screen frame cropping apparatus, comprising:
a touch screen;
a storage unit, recording a plurality of modules; and
one or a plurality of processing units, coupled to the touch screen and the storage unit, and accessing and executing the modules recorded in the storage unit, wherein the modules comprise:
a display module, displaying a frame on the touch screen;
a detection module, detecting a first touch and a second touch performed by a user on the touch screen; and
a cropping module, storing a cropped frame of the frame as an image file when the first touch and the second touch satisfy a predetermined condition;
wherein the cropped frame is determined according to at least one first touch position of the first touch and at least one second touch position of the second touch.

11. The screen frame cropping apparatus according to claim 10, wherein the predetermined condition comprises one of a first displacement of the first touch and a second displacement of the second touch being greater than a predetermined value.

12. The screen frame cropping apparatus according to claim 11, wherein the predetermined condition comprises one of the first touch and the second touch starting from a predetermined starting border area of the touch screen.

13. The screen frame cropping apparatus according to claim 10, wherein the cropped frame is determined according to a first starting touch position of the first touch, a second starting touch position of the second touch, and a first current touch position of the first touch and a second current touch position of the second touch when one of a first displacement of the first touch and a second displacement of the second touch is greater than a predetermined value.

14. The screen frame cropping apparatus according to claim 10, wherein the cropped frame is a rectangle comprising a cropping area and a transparent area outside the cropping area, wherein the cropping area and the transparent area are determined according to a first moving path of the first touch and a second moving path of the second touch.

15. The screen frame cropping apparatus according to claim 10, wherein the modules further comprise:
a character recognition module, recognizing the cropped frame by using a character recognition technique to generate at least one character, and storing the at least one character as a text file.

16. The screen frame cropping apparatus according to claim 10, wherein the predetermined condition comprises one of the first touch and the second touch ending at a predetermined ending border area of the touch screen.

17. The screen frame cropping apparatus according to claim 10, wherein the predetermined condition comprises one of a first touch time of the first touch and a second touch time of the second touch being greater than a predetermined value.

18. The screen frame cropping apparatus according to claim 10, wherein the cropped frame is determined according to a first starting touch position of the first touch, a second starting touch position of the second touch, a first ending touch position of the first touch, and a second ending touch position of the second touch.

19. A computer program product, loaded into an electronic apparatus to execute following steps:
displaying a frame on a touch screen of the electronic apparatus;
detecting a first touch and a second touch performed by a user on the touch screen; and
when the first touch and the second touch satisfy a predetermined condition, storing a cropped frame of the frame as an image file;
wherein the cropped frame is determined according to at least one first touch position of the first touch and at least one second touch position of the second touch.
